(19) United States
(12) Patent Application Publication
(10) Pub. No.: US 2016/0279858 A1
(43) Pub. Date: Sep. 29, 2016

(54) METHODS AND APPARATUS RELATING TO BEVERAGE CAPSULES

(71) Applicant: KONINKLIJKE DOUWE EGBERTS B.V., Utrecht (NL)

(72) Inventors: John Melrose, Banbury (GB); Andrew Halliday, Banbury (GB); Simon Philip Jelley, St Ives (GB)

(21) Appl. No.: 15/036,787

(22) PCT Filed: Nov. 19, 2014
(86) PCT No.: PCT/IB2014/002626

§ 371 Date: May 13, 2016

(30) Foreign Application Priority Data
Nov. 20, 2013 (GB) 1320483.9

(51) Int. Cl. B29C 59/00; B65D 85/804; B29C 59/16

(52) U.S. Cl. CPC B29C 59/007; B29C 59/16; B65D 85/8043; B29C 2791/009; B29K 2023/06; B29K 2023/12

(57) ABSTRACT

A method of producing a body portion (2) of a capsule (1) comprises forming the body portion (2) from a polymeric material and subsequently treating one or more piercing zones (30) of the body portion (2) to alter one or more material characteristics of the polymeric material of the piercing zone(s) relative to the material characteristics of the polymeric material of a remainder of the body portion (2). A capsule (1) for the preparation of a beverage comprises a body portion (2) comprising one or more piercing zones (30) intended to be pierced in use by one or more piercers (13) of a beverage preparation machine to provide one or more inlet apertures for feeding water under pressure into the interior of the capsule (1). The body portion (2) is formed from a polymeric material. The polymeric material of the piercing zone(s) comprises a transformed structure which has been treated after formation of the body portion (2) to alter one or more of its material characteristics.

The present disclosure relates to methods and apparatus relating to beverage capsules. In particular, it relates to a capsule for the preparation of a beverage, for example coffee, when utilised with a beverage preparation machine, the capsule comprising a body portion and a lid which together define an interior of the capsule for containing beverage ingredients. Further, the disclosure relates to methods for producing said capsules and components thereof.

### BACKGROUND OF THE DISCLOSURE

Disposable beverage capsules formed from aluminium have been known for many years. An example is described in EP0512470. The capsule of that document comprises a frustroconically-shaped cup which is filled with coffee and is closed by an aluminium cover joined to a rim which extends from a side-wall of the cup. A capsule holder of a brewer designed to receive the capsules comprises a flow grill with relief surface element members. The brewer further comprises a water injector and an annular element with an internal recess of which the shape substantially corresponds to the outer shape of the capsule.

In operation, the capsule of EP0512470 is placed in the capsule holder. The water injector perforates an upper, inlet face of the capsule. The aluminium cover of the capsule rests on the relief surface element members of the capsule holder. Water is injected through the water injector and contacts the coffee. The capsule is pressurised by the water causing the aluminium cover to be distorted outwardly and be torn against the relief surface element members. Extracted coffee flows through the torn aluminium cover and the flow grill to be discharged by the brewer into a receptacle, for example a cup.

It is also known to provide an inlet face of the capsule with pre-formed inlet apertures that do not require piercing. However, this results in the disadvantage that coffee can be lost from the capsule during handling and transport and can lead to oxidization of the coffee during storage. Thus, it is preferred to use closed or sealed capsules in which the inlet apertures for feeding water into the capsule to contact the beverage ingredient are created by the beverage preparation machine at the time of beverage formation. For this purpose the brewing device is typically provided with an inlet piercer which may take the form of one or more protruding parts, such as needles or blades, which are moved with respect to the capsule (or vice versa) to perforate the capsule.

More recently, it has been known to manufacture beverage capsules of the general configuration described above, at least in part, from a polymeric material. For example, it is known to combine a cup-shaped body portion formed from a material such as a PE or PP polymer, with an aluminium-based cover to form the capsule. An example of such is described in WO2010/041179. One potential problem is that beverage capsules made of a polymer such as PE or PP can be difficult to perforate using the inlet piercer of known beverage preparation machines. For example, the material of the capsule may deflect or distort during the piercing stage resulting in the inlet aperture not being fully formed and the aperture therefore having a smaller open area than desired. In another example the force applied by the inlet piercer may be insufficient to fully form an inlet aperture of desired size in the material of the capsule, in particular where the material of the capsule is a relatively resilient polymeric material. In extreme cases, the capsule material may deflect or distort to such an extent, or the material of the capsule may be sufficiently resilient, that no aperture is formed at all.

Attempts have been made to overcome this problem by altering the geometry of the capsule to reinforce the capsule in the region where the inlet apertures are to be formed. WO2010/041179 describes that the capsule may comprise a sunken portion provided in the inlet wall. This sunken portion is intended to be a reinforcing element that cooperates with a corresponding radial ridge on the inlet wall. WO2012/080501 describes a capsule where the base (that is the inlet wall) of the capsule is provided with a reinforcement zone arranged circumferentially on the base as a plurality of recesses. However, altering the geometry of the capsule requires a complete redesign of the capsule and can lead to the capsule becoming incompatible for use in some beverage preparation machines. In addition, increasing the reinforcement of the inlet wall can increase the problem of forming inlet apertures where the force applied by the inlet piercer is relatively low.

### SUMMARY OF THE DISCLOSURE

In one aspect the present disclosure provides a method of producing a body portion of a capsule comprising the steps of:

forming the body portion from a polymeric material;

subsequently treating one or more piercing zones of the body portion to alter one or more material characteristics of the polymeric material of the one or more piercing zones relative to the material characteristics of the polymeric material of a remainder of the body portion.

Advantageously, by altering one or more of the material characteristics of the one or more piercing zones the body portion can be configured as desired to allow it be pierced sufficiently and reliably in use by a beverage preparation machine. Since the alteration takes place after formation of the body portion, the technique can be applied to body portions of any geometry and does not require a wholesale change in the shape of the capsule intended to be formed from the,body portion.

In addition, advantageously, the material characteristics of different zones of the body portion can be controlled by treating one or more zones of the body portion after moulding. This can avoid the need and complication of trying to form a body portion from multiple different materials. For example, the body portion may comprise a zone intended to form a sealing interface with an enclosing member of a beverage preparation machine in which it will be used. It can be beneficial to use a relatively ductile or soft material for this zone of the body portion to allow a better seal to be formed. However, the zone or zones of the body portion intended to be pierced can benefit from being made relatively brittle or easier to pierce. The present disclosure advantageously allows the material characteristics of different portions of the body portion to be accurately controlled.

Treating the one or more piercing zones may comprise exposing the one or more piercing zones to radiant energy.

Advantageously, the use of radiant energy provides an accurate means for selectively treating portions of the body portion. Portions which are not intended to be treated may be masked so as not to be exposed to the radiant energy.

Treating the one or more piercing zones may comprise exposing the one or more piercing zones to electromagnetic radiation.

The electromagnetic radiation may be one or more of infrared radiation, visible light radiation, ultraviolet radiation, soft X-ray radiation, X-ray radiation, gamma-ray radiation, and electron beam radiation.

Treating the one of more piercing zones may comprise one or more of degrading, carbonising, foaming, ageing or embrittling the polymeric material.

Degrading, foaming and/or carbonisation of the polymeric material can have the advantage that the polymeric material of the one or more piercing zones is made structurally weaker and is hence more easily pierced by the needles or blades of the inlet piercer. In particular, whilst not wishing to be bound by theory, the treatment may lead to changes in the physical material properties through polymer chain scission processes and/or post-crystallisation.

Aging or embrittling of the polymeric material can have the advantage that excessive deflection or distortion of the capsule during piercing can be limited or prevented since the polymeric material of the one or more piercing zones is made more brittle than before exposure. In addition, the comparatively aged or brittle polymeric material has an increased tendency to crack and/or fracture on failure (as opposed to a ductile ‘tearing’ mode of failure that predominates in softer polymeric materials) under the loading of the needles or blades of the inlet piercer (which tend to apply one or more point loads to the polymeric material). Fracturing and/or cracking of the polymeric material has been found to have a tendency to form inlet apertures that are larger in area than the area of the impinging inlet piercer since the fractures and/or cracks in the polymeric material have a tendency to propagate outwards away from the location of the point loading. Consequently, provision of the comparatively brittle material can lead to the formation of enlarged inlet apertures with a resultant increased flow area for the ingress of pressurised water into the capsule.

The radiant energy may be applied to the one or more piercing zones in the form of a focused beam.

The one of more piercing zones may be subjected to laser treatment.

The body portion may be moulded from the polymeric material. The body portion may be formed as a unitary moulding. The body portion may be moulded from a single material. The body portion may be injection-moulded.

The body portion may be formed from a material comprising a polyolefin. The body portion may be formed from a material comprising a thermoplastic polyolefin. The body portion may be formed from a material comprising polypropylene and/or polyethylene. Alternatively, other polymers may be used, for example polylactic acid (PLA).

The polymeric material may comprise an additive intended to facilitate the treatment of the one or more piercing zones by radiant energy. The additive may be one or more compounds selected from the group of: carbon black, graphite and doped-tin dioxide.

The tin dioxide may be doped with one or more of antimony, fluorine, chlorine, tungsten, molybdenum, iron or phosphorus.

The body portion may be moulded in a cup-shape. The body portion may comprise an inlet wall, wherein the one or more piercing zones are located on the inlet wall. The one or more piercing zones may comprise an annular zone. The annular zone may be continuous in a circumferential direction. Alternatively, the annular zone may be discontinuous in a circumferential direction. In an example, the annular zone may comprise a circumferential pattern, preferably a repeating pattern.

The one or more piercing zones may comprise two or more concentrically arranged annular zones.

The one or more piercing zones may comprise a circular zone.

The body portion may have a thickness within the one or more piercing zones in the range of 0.20 to 0.50 mm, preferably within the range 0.30 to 0.40 mm.

The one or more piercing zones may comprise an area of 10 to 90% of an inlet wall area of the body portion.

The method may further comprise masking of the polymeric material of a remainder of the body portion to prevent alteration of said remainder of the body portion during treatment.

The body portion may further comprise a sealing member configured to form a sealing engagement with an enclosing member of a beverage preparation machine to thereby prevent or limit a by-pass flow of water in use. The sealing member may form a part of the remainder of the body portion which is not treated. The one or more piercing zones of the body portion may have a lower ductility than the sealing member.

The present disclosure also relates to a method of producing a capsule for the preparation of a beverage comprising the steps of:

producing a body portion as described above;

inserting beverage ingredients into the body portion; and

sealing the body portion with a lid.

The present disclosure further relates to a body portion of a capsule obtainable by the method as described above.

In another aspect, the present disclosure provides a capsule for the preparation of a beverage when utilised with a beverage preparation machine, the capsule comprising a body portion and a lid which together define an interior of the capsule for containing beverage ingredients;

wherein the body portion comprises one or more piercing zones intended to be pierced in use by one or more piercers of the beverage preparation machine to thereby provide one or more inlet apertures for feeding water under pressure into the interior of the capsule;

wherein the body portion is formed from a polymeric material;

wherein the polymeric material of the one or more piercing zones comprises a transformed structure which has been treated after formation of the body portion to alter one or more material characteristics of the polymeric material of the one or more piercing zones relative to the material characteristics of the polymeric material of a remainder of the body portion.

The transformed structure may comprise one or more of a degraded, carbonised, foamed, aged or embrittled structure.

The body portion may be moulded from the polymeric material. The body portion may be a unitary moulding. The body portion may be moulded from a single material. The body portion may be injection-moulded.

The body portion may be formed from a material comprising a polyolefin. The body portion may be formed from a material comprising a thermoplastic polyolefin. In one example, the body portion is formed from a material comprising polypropylene and/or polyethylene.

The polymeric material may comprise an additive intended to facilitate the treatment of the one or more piercing zones by radiant energy. The additive may be one or more compounds selected from the group of: carbon black, graphite and doped-tin dioxide. The tin dioxide may be doped with one or more of antimony, fluorine, chlorine, tungsten, molybdenum, iron or phosphorus.

The body portion may be cup-shaped. The body portion may comprise an inlet wall, wherein the one or more piercing zones are located on the inlet wall.

The one or more piercing zones may comprise an annular zone. The annular zone may be continuous in a circumferential direction. Alternatively, the annular zone may be discontinuous in a circumferential direction. In an example, the annular zone may comprise a circumferential pattern, preferably a repeating pattern.

The one or more piercing zones may comprise two or more concentrically arranged annular zones.

The one or more piercing zones may comprise a circular zone.

The body portion may further comprise a sealing member configured to form a sealing engagement with an enclosing member of a beverage preparation machine to thereby prevent or limit a by-pass flow of water in use.

The sealing member may form a part of the remainder of the body portion which is not treated.

The one or more piercing zones of the body portion may have a lower ductility than the sealing member.

### BRIEF DESCRIPTION OF THE DRAWINGS

Embodiments of the present disclosure will now be described, by way of example only, with reference to the accompanying drawings, in which:

FIG. 1 is a. schematic view of a capsule according to the present disclosure;

FIG. 2 is a schematic view of the capsule of FIG. 1 inserted into a beverage preparation machine and prior to piercing;

FIG. 3 is an equivalent view to FIG. 2 after piercing of an inlet end of the capsule;

FIG. 4 is a schematic end view of the capsule of FIG. 1;

FIG. 5 is a schematic representation of a first apparatus for treating a cup-shaped body of the capsule of FIG. 1;

FIGS. 6a and 6b are photographs showing pierced inlet holes in a sample capsule not subject to a treatment of the present disclosure;

FIGS. 7a and 7b are photographs showing pierced inlet holes in a sample capsule subject to an embrittlement treatment of the present disclosure;

FIG. 8 is a schematic representation of a second apparatus for treating a cup-shaped body of the capsule of FIG. 1;

FIG. 9 is a schematic representation of third apparatus for treating a cup-shaped body of the capsule of FIG. 1; and

FIGS. 10a to 10f show schematically examples of arrangements of piercing zone(s).

### DETAILED DESCRIPTION

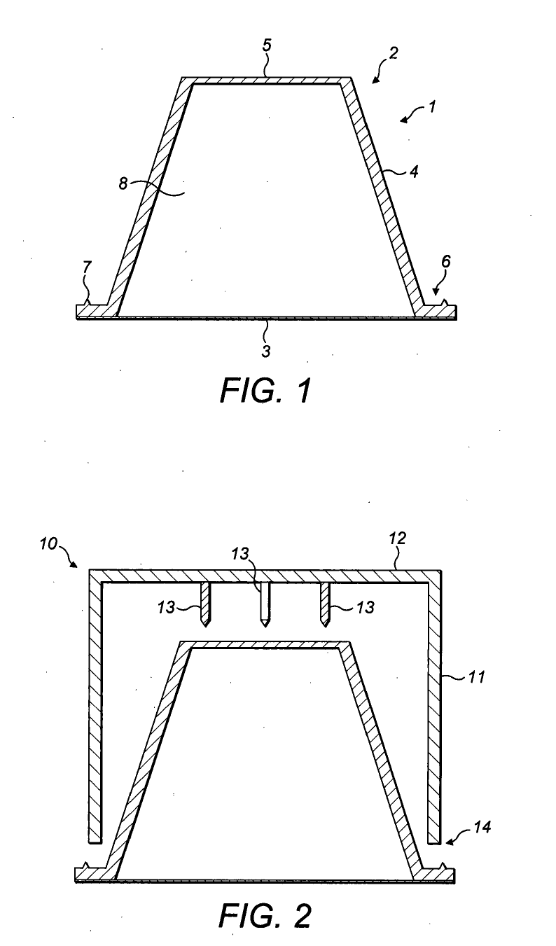

In the following description, embodiments of the present disclosure will be described by way of example only with reference to a representative design of capsule 1 as shown in FIG. 1. However, the present disclosure is not limited to use with capsules of the particular design shown in FIG. 1.

The example capsule of FIG. 1 comprises a cup-shaped body portion 2 and a lid 3.

The cup-shaped body portion 2 is formed from a polymeric material as a single, unitary injection moulding. Examples of suitable material for forming the cup-shaped body portion 2 include polyolefins, including thermoplastic polyolefins. In one example the cup-shaped body portion 2 is formed from a material comprising polypropylene and/or polyethylene.

The cup-shaped body portion 2 comprises a bottom wall 5, forming an inlet end of the capsule 1, a side wall 4 extending away from the bottom wall 5 and an outwardly-extending flange 6. A sealing element 7 may be provided on the flange 6. In the illustrated example, the sealing element 7 takes the form of an integral circumferential rib protruding from the surface of the flange 6.

The lid 3, which may be formed from a suitable material such as aluminium foil, a polymeric laminate or a combination thereof, is adhered or otherwise sealed to the flange 6 so as to close the cup-shaped body portion 2 to define an interior 8 of the capsule which in use can be packed with a beverage ingredient such as roasted ground coffee.

In accordance with the present disclosure, and common to each of the embodiments described in more detail below, the cup-shaped body portion 2 is subjected to a treatment step, after its formation. The treatment results in alteration of the material characteristics of at least a portion of the cup-shaped body portion 2 compared to the polymeric material of a remainder of the cup-shaped body portion 2. More particularly, one or more piercing zones 30 of the cup-shaped body portion 2 are so treated.

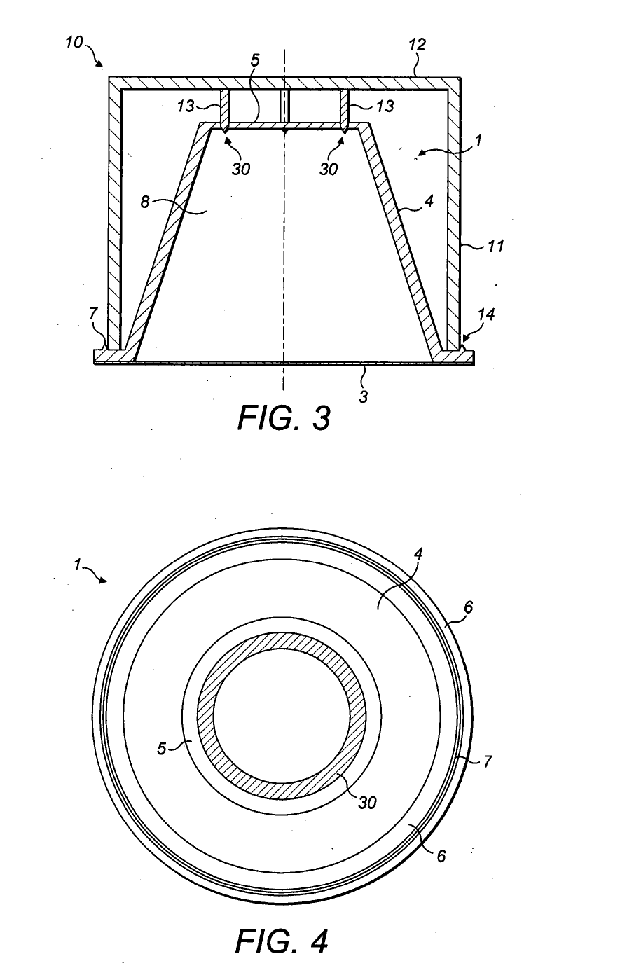

The ‘one or more piercing zones’ 30 of the cup-shaped body portion 2 encompass those one or more areas of the cup-shaped body portion 2 which are intended, in use, to be pierced by the beverage preparation machine in which the capsule 1 is utilised. The location of the one or more piercing zones 30 may vary depending on the design of the inlet piercing arrangement of the beverage preparation machine. For example, a schematic representation of one type of inlet piercing arrangement is shown in FIGS. 2 and 3. In these figures only a portion of the beverage preparation machine is shown and this is shown schematically for ease of understanding. As shown, an upper enclosing member 10 of the beverage preparation machine is provided which has a base wall 12 from which the inlet piercing arrangement in the form of three piercers 13 extend. In addition, the upper enclosing member 10 comprises a circumferential side wall 11 which terminates at an annular rim 14.

In this illustrated example, the three piercers 13 are located in a circular arrangement around a nominal central longitudinal axis of the upper enclosing member 10. Consequently, in use the bottom wall 5 of the capsule 1 will be pierced at three points which lie in a circular arrangement around a central longitudinal axis of the capsule 1. Consequently, the one or more piercing zones 30 for this example may be considered to be a single annular piercing zone 30 as shown in FIG. 4. In this example, the piercing zone 30 forms only a portion of the bottom wall 5. This annular piercing zone 30 encompasses each of the three locations that will be pierced in use by the piercers 13 of the beverage preparation machine whatever the rotational orientation of the capsule 1 about its longitudinal axis. It can be noted that in use not all of the material of the one or more piercing zones 30 need be pierced by the piercers 13.

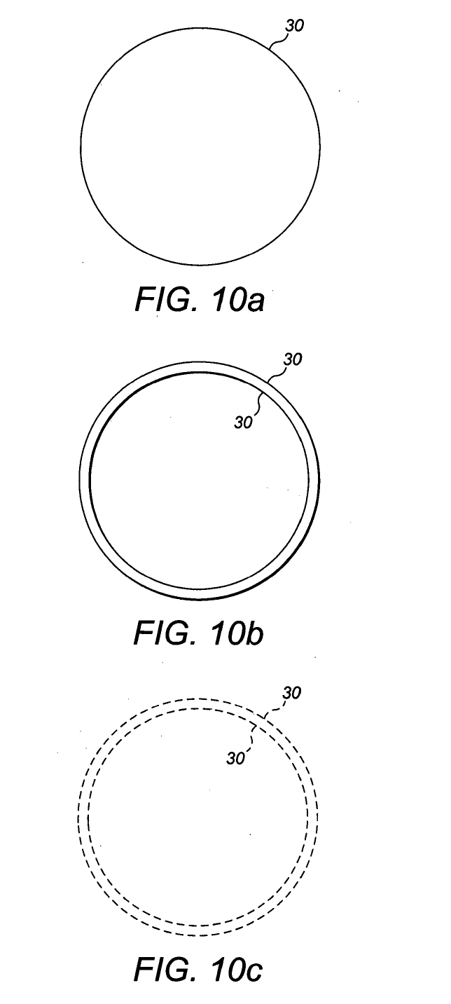

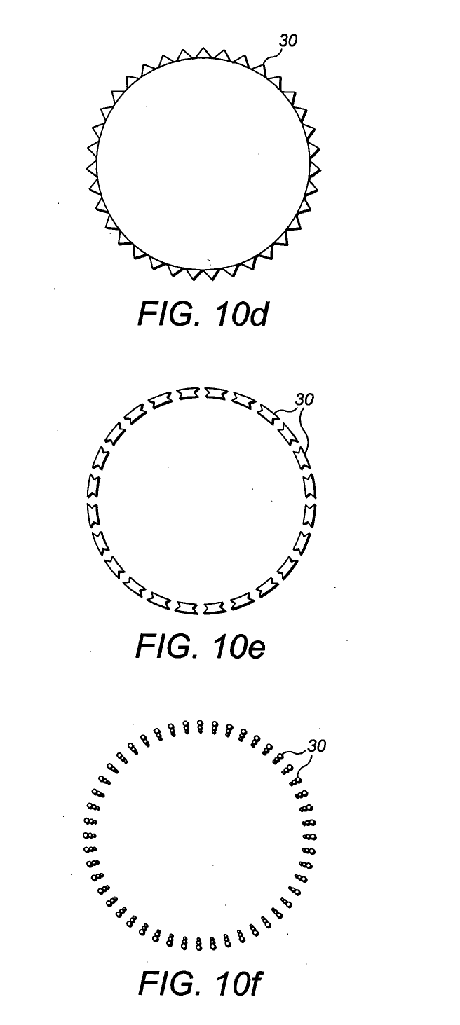

FIGS. 10a to 10f illustrate schematically, by way of example only, a variety of arrangements for the one or more piercing zones 30 that may be used.

In the example of FIG. 10a, as in FIG. 4, the one or more piercing zones 30 comprise a single, circumferentially continuous annular zone.

In the example of FIG. 10b the one or more piercing zones 30 comprise two circumferentially continuous annular zones which are arranged concentrically with respect to each other, preferably centred on the longitudinal axis of the cup-shaped body portion 2.

In the example of FIG. 10c the one or more piercing zones 30 comprise two circumferentially discontinuous annular zones having a ‘dashed line’ appearance and which are arranged concentrically with respect to each other, preferably centred on the longitudinal axis of the cup-shaped body portion 2.

In the example of FIG. 10d the one or more piercing zones 30 comprise a single annular circumferential pattern, preferably a repeating pattern as shown. In this example the repeated unit is shaped as a triangle and the repeated units directly adjoin one another such that the circumferential pattern is continuous in the circumferential direction.

The example of FIG. 10e is similar to that of FIG. 10d except that the repeated unit is shaped as a hexagonal shape having inverted points and the repeated units are spaced from one another such that the circumferential pattern is discontinuous in the circumferential direction.

In the example of FIG. 10f the one or more piercing zones 30 again comprise a circumferential pattern, preferably a repeating pattern as shown. In this example the repeated unit is shaped is a group of three circular areas of decreasing size. Each repeated unit is spaced from one another.

It will be appreciated that a great variety of arrangements of the one or more piercing zones 30 can be used without departing from the scope of the present disclosure.

The bottom wall 5 of the capsule 1 may typically have a thickness in the range 0.20 to 0.50 mm, more typically in the range 0.30 to 0.40 mm. In one example the thickness is 0.35 to 0.38 mm. The thickness'of the bottom wall 5 may vary across the extent of the bottom wall 5 or may alternatively be uniform.

The capsule 1 is sized and configured to be received within the upper enclosing member 10.

In use the capsule 1 is inserted into the beverage preparation machine and the upper enclosing member 10 is moved from a position generally of that shown in FIG. 2 to a position as shown in FIG. 3 in which the upper enclosing member 10 has been moved relative to the capsule 1 such that the annular rim 14 seals against the flange 6 of the capsule 1. (For ease of reference, the lower enclosing member and its associated outlet piercing arrangement of the beverage preparation machine which pierces the lid 3 has been omitted from the figures). In so doing, the sealing element 7 may contribute to the integrity of the seal so formed. As can be seen from FIG. 3, the movement of the upper enclosing member 10 causes the piercers 13 to contact and pierce the polymeric material of the bottom wall 5 of the capsule 1. The piercing of the bottom wall 5 allows for ingress of water into the interior 8 to form a beverage from interaction with beverage ingredients held in the capsule 1. The beverage is then output via apertures formed in the lid 3 by the outlet piercing arrangement of the beverage preparation machine.

The treatment step may be exposing the one or more piercing zones 30 to radiant energy. In order to achieve this treatment, the polymeric material of the one or more piercing zones 30 may be exposed to a radiant energy source. The radiant energy source emits radiant energy in a manner such that the one or more piercing zones 30 are exposed to the radiant energy.

A mask, either as part of the radiant energy source or separate therefrom, may be provided to control which parts of the material of the cup-shaped body portion 2 are exposed to the radiant energy. For example, the mask may be a separate element from the cup-shaped body portion 2 which is interposed between the cup-shaped body portion 2 and the radiant energy source or may alternatively be a layer of suitable material which is temporarily or permanently applied to the surface of the polymeric material of the cup-shaped body portion 2. Any suitable material for the mask may be used which is opaque to the radiant energy being utilised.

The radiant energy source may be any only suitable source capable of generating and emitting the required type of radiant energy. The radiant energy source may comprise a mechanism for generating a focussed beam of radiant energy. Alternatively, or in addition, one or more focusing elements may be interposed between the radiant energy source and the cup-shaped body portion 2 to focus the radiant energy onto the polymeric material of the one or more piercing zones 30.

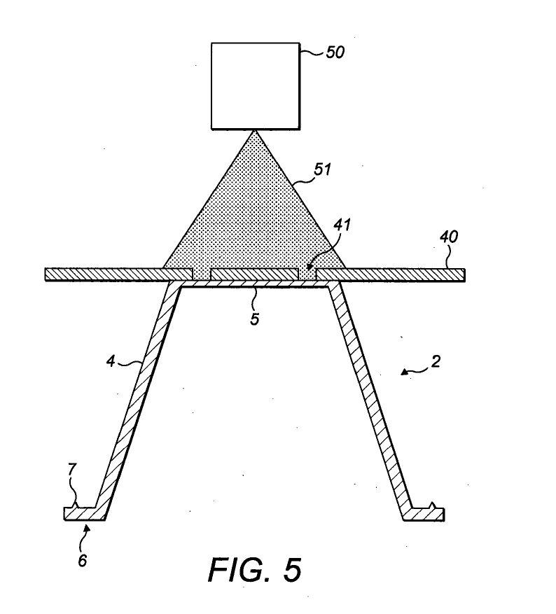

FIG. 5 illustrates a first example of a treatment apparatus wherein the polymericmaterial of the one or more piercing zones 30 is subjected to a treatment involving exposure to ultraviolet (UV) radiation 51 from a UV source 50. The treatment is carried out after moulding of the cup-shaped body portion 2 to render the material of the one or more piercing zones 30 comparatively brittle compared to the polymeric material of a remainder of the cup-shaped body portion 2.

As illustrated, a mask 40 is interposed between the UV source 50 and the cup-shaped body portion 2. The mask 40 comprises an annular aperture 41 which allows the UV radiation 51 to contact the polymeric material of the cup-shaped body portion 2 in an annular zone immediately below the annular aperture 41 but prevents exposure of a remainder of the polymeric material of the cup-shaped body portion 2.

If desired, additives may be added to the polymer material to speed up the embrittlement reaction.

A comparative study was undertaken of cup-shaped body portions 2 embrittled using UV radiation. The cup-shaped body portions 2 were injection moulded from Rigidex® polymer, a high density polyethylene. The cup-shaped body portions 2 were moulded to have a bottom wall 5 of thickness 0.3 mm.

A first test group of the cup-shaped body portions 2 were exposed to an ultraviolet (UV) light source, in the form of two 9 W ultraviolet lamps, emitting ultra-violet radiation at a wavelength of 254 nm. The exposure was continued for 190 hours. A second, control group of cup-shaped body portions 2 were not exposed to the UV light source and were retained for the same time period of 190 hours.

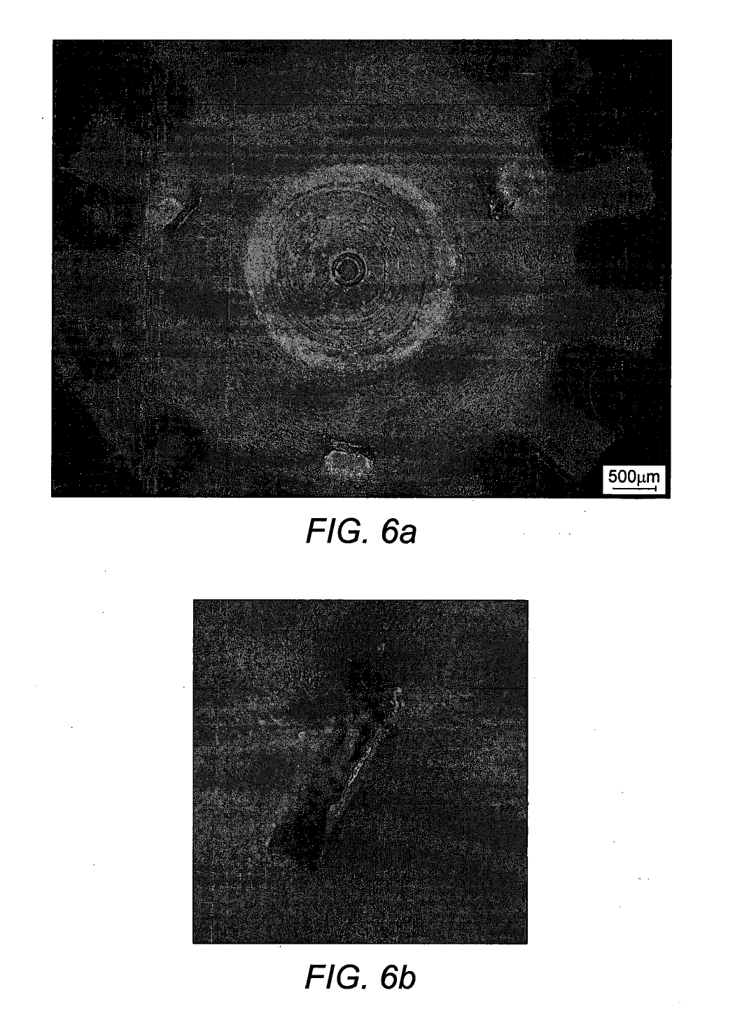

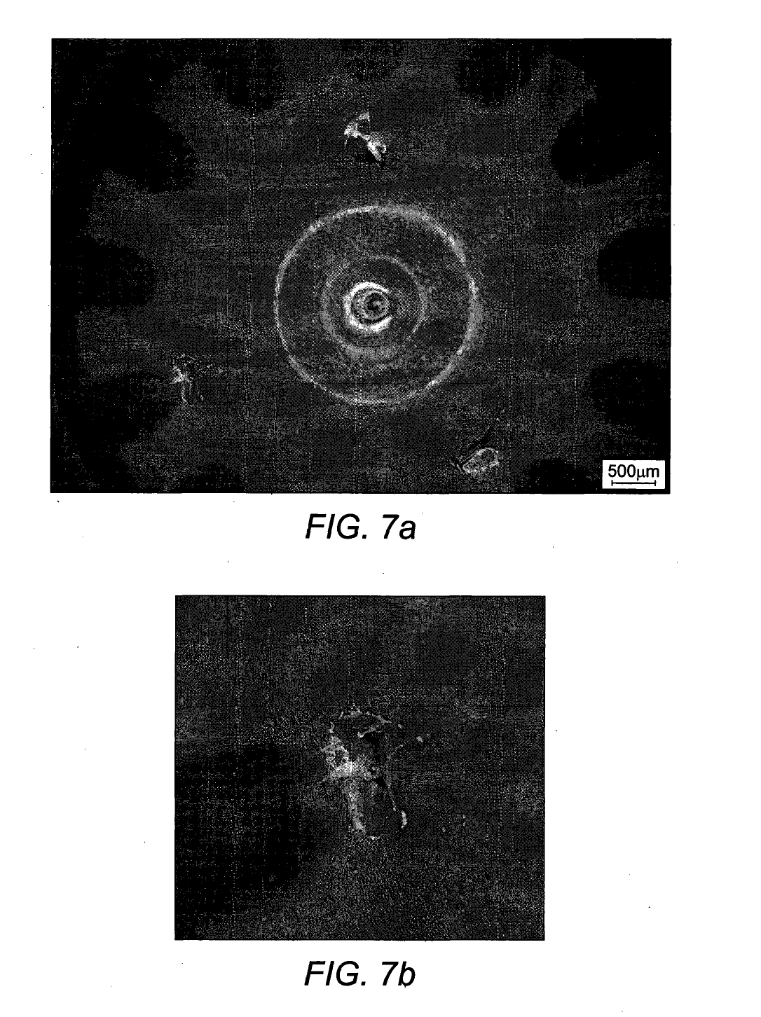

At the conclusion of the exposure, piercing tests were carried out on the bottom walls 5 of the cup-shaped body portions 2 using a Zwick 250kN test machine at a speed of 15 mm/minute. FIGS. 6a and 6b illustrate the typical appearance of the bottom wall 5 of the cup-shaped body portions 2 of the second, control group after piercing. FIGS. 7a and 7b show equivalent views for the cup-shaped body portions 2 from the first test group that were exposed to the UV radiant energy source.

Comparison of the failure modes obtained for the control group and the test group show a clear difference in the nature of the failure of the polymeric material. The pierced regions of the cup-shaped body portions 2 that were not exposed show a smoother-boundary failure with indications of ductility. In contrast, the cup-shaped body portions 2 exposed to the UV radiation show crazed failure regions with uneven boundary failure and evidence of cracks penetrating radially outwards from the location of the piercers.

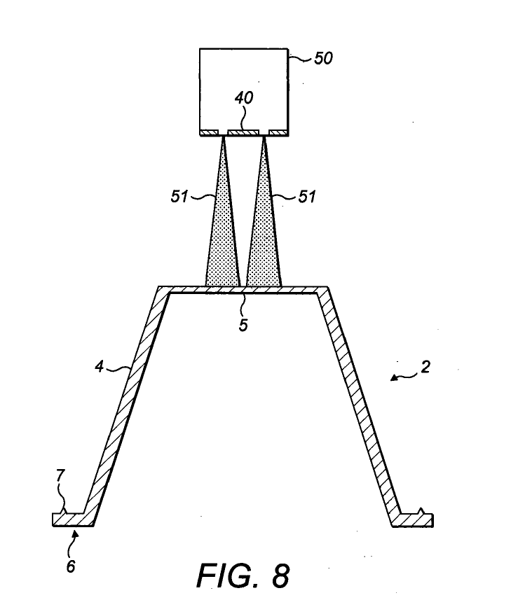

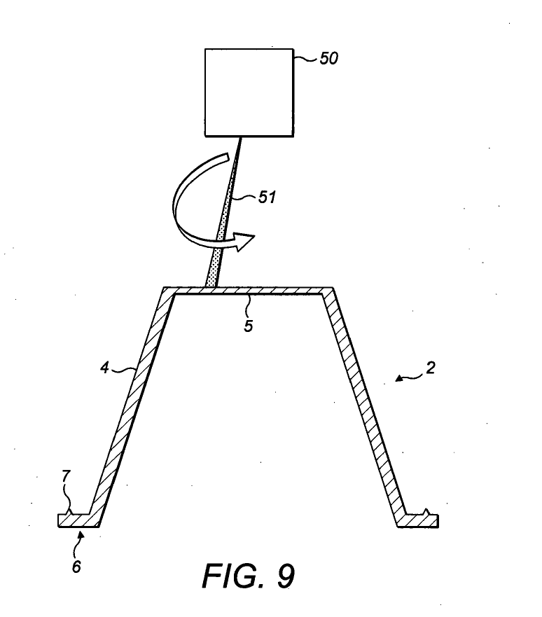

FIGS. 8 and 9 illustrate second and third examples of treatment apparatus wherein the polymeric material of the one or more piercing zones 30 is subjected to a treatment involving exposure to radiation 51 from a laser source 50. The treatment is carried out after moulding of the cup-shaped body portion 2 to degrade, foam and/or carbonise the material of the one or more piercing zones 30. This weakens the material of the one or more piercing zones 30 and renders it more easily pierceable.

The apparatus illustrated schematically in FIG. 8 depicts an example of photo masking laser treatment. In photo masking laser treatment the laser source is projected against a mask 40 or template representing the area to be treated. In the illustrated example the mask 40 defines an annular treatment area. The filtered laser beam then passes through an optical lens arrangement which concentrates the laser beam 51 with a high energy onto the cup-shaped body portion 2.

Typically for photo masking laser treatment the laser is a CO₂ laser with a wavelength of 10600 nm. The pulse frequency of the laser is typically higher than 100 Hz and the laser power is typically in the range 10-200 W. As the whole area to be treated is exposed at the same time, the treatment is very rapid.

The apparatus illustrated schematically in FIG. 9 depicts an example of beam steering laser treatment. In beam steering laser treatment the laser beam 51 is steered using two galvanometer-operated mirrors to trace out the required treatment area. Thus use of a mask is not essential (although an interposed mask can be used as well if desired).

Typically for beam steering laser treatment the laser is a Nd:YAG (Neodymium doped Yttrium Aluminium Garnet) laser with a wavelength of 1064 nm (infrared light) or a doubled Nd:YAG laser with a wavelength of 532 nm (green light). The laser power is typically in the range 2.5-10 W for a Nd:YAG laser and 1-3 W for a doubled Nd:YAG laser. To beneficial produce heat generation in the polymer material it is typical to use high pulse rate frequencies in the range 1 to 50 kHz.

As noted above, with both methods of laser treatment the goal is to produce degradation, foaming and/or carbonisation of the material of the one or more piercing zones 30. Degradation is the degrading of one or more of the material characteristics of the polymer material (such as strength, ductility, elasticity) due, in the example case, to the localised heating of the polymer material. Foaming is the generation of gases in the polymer due to burning or evaporation of compounds. The hot gases produced are within the polymer matrix so produce expanded bubbles. Carbonisation or charring is where degradation of the polymer material is sufficient to cause localised burning of the polymer material.

The effects produced by the laser treatment may be generated throughout the thickness of the material of the one or more piercing zones 30 or may only be used to affect a surface region of the material.

Different polymer materials have differing responses to laser treatment. Even with the same polymer, different grades and different colours of polymer can respond differently to the laser radiation. Consequently, one or more additives can be added to the polymer material to improve is suitability for laser treatment. For example, additives such as carbon black, graphite and doped-tin dioxide may be added. One example is the Mark-it™ Laser Marking Pigment produced by BASF Corporation which contains an antimony-doped tin oxide pigment. Typically, the additive in the polymer acts as an element that readily absorbs the laser radiation and generates heat which then affects the surrounding polymer matrix. Thus, even polymers which might otherwise be ‘transparent’ to radiation at the wavelength of the laser source can be treated.

In the present description the disclosure has been described by way of example only with reference to the design of capsule 1 shown in the attached Figures. A number of alternatives will be understood to be within the scope of the disclosure as set out in the appended claims.

For example, the body portion 2 of the capsule may be other than cup-shaped.

For example, it has been described that the cup-shaped body portion 2 may comprise a sealing element 7 in the form of a circumferential rib protruding from the surface of the flange 6. However, other forms of sealing element may also be provided either on the flange 6 or on other portions of the cup-shaped body portion 2, such as the bottom wall 5 or side wall 4. For example the sealing element 7 may take the form of a plurality of ridges, a step formation, an inclined surface or similar geometric form which achieves the necessary sealing interface with the upper enclosing member of the beverage preparation machine.

For example, while the description has described the cup-shaped body portion 2 being formed from a single unitary moulding, the cup-shaped body portion 2 may be formed from more than one piece and may be formed by methods other than injection moulding. In addition, the cup-shaped body portion 2 may be formed from two or more different materials. For example, it may be formed as a co-moulding of two different polymeric materials.

For example, in the attached Figures the capsule has been shown in schematic form and in particular, the cup-shaped body portion 2 has been shown in a simplified manner showing simply the bottom wall 5, side wall 4 and an outwardly extending flange 6. However, other features may be present as part of the cup-shaped body portion 2 as well known in the art. For example one or more reinforcing structures may be provided, for example ridges or ribs for strengthening the structure of the cup-shaped body portion 2. The capsule 1 may also be provided with an internal filter at or near the inlet end of the bottom wall 5 and/or the outlet end of the lid 3.

For example, in the above description, the beverage preparation machine is provided with three piercers 13 which pierce the bottom wall 5 along an annular or circular path around the longitudinal axis of the capsule 1. The reader will understand that a wide range of other piercing arrangements can be contemplated. Consequently, an equally wide range of shapes, sizes and locations of the one or more piercing zones 30 can be contemplated. For example, the one or more piercing zones 30 may comprise one or more circular areas as opposed to annular areas; the one or more piercing zones 30 may extend to cover the whole of the bottom wall 5; the one or more piercing zones 30 may not be rotationally symmetric about the longitudinal axis of the capsule 1—in particular where the shape or design of the capsule 1 prevents its rotation within the upper enclosing member of the beverage preparation machine.

For example, in the above description, the capsule 1 has been described having a lid 3 which in use is torn or pierced by a lower enclosing member of the beverage preparation machine. However, the capsule 1 may take other forms, for example wherein the outlet of the capsule is formed as a pre-pierced or porous sheet or wall which is not intended to be pierced or torn by the lower enclosing member of the beverage preparation machine in use.

1. A method of producing a body portion of a capsule comprising the steps of:
forming the body portion from a polymeric material;
subsequently treating one or more piercing zones of the body portion to alter one or more material characteristics of the polymeric material of the one or more piercing zones relative to the material characteristics of the polymeric material of a remainder of the body portion.

2. The method of claim 1 wherein treating the one or more piercing zones comprises exposing the one or more piercing zones to radiant energy.

3. The method of claim 2 wherein treating the one or more piercing zones comprises exposing the one or more piercing zones to electromagnetic radiation.

4. The method of claim 3 wherein the electromagnetic radiation is one or more of infrared radiation, visible light radiation, ultraviolet radiation, soft X-ray radiation, X-ray radiation, gamma-ray radiation, and electron beam radiation.

5. The method of claim 1 wherein treating the one of more piercing zones comprises one or more of degrading, carbonising, foaming, ageing or embrittling the polymeric material.

6. The method of claim 1 wherein the radiant energy is applied to the one or more piercing zones in the form of a focused beam.

7. The method of claim 1 comprising laser treatment of the one or more piercing zones.

6. The method of claim 1 wherein the body portion is moulded from the polymeric material.

9. The method of claim 1 wherein the body portion is formed as a unitary moulding.

10. The method of claim 1 wherein the body portion is moulded from a single material.

11. The method of claim 1 wherein the body portion is injection-moulded.

12. The method of claim 1 wherein the body portion is formed from a material comprising a polyolefin.

13. The method of claim 1 wherein the body portion is formed from a material comprising a thermoplastic polyolefin.

14. The method of claim 1 wherein the body portion is formed from a material comprising polypropylene and/or polyethylene.

15. The method of claim 1 wherein the polymeric material comprises an additive intended to facilitate the treatment of the one or more piercing zones by radiant energy.

16. The method of claim 15 wherein the additive is one or more compounds selected from the group of: carbon black, graphite and doped-tin dioxide.

17. The method of claim 16 wherein the tin dioxide is doped with one or more of antimony, fluorine, chlorine, tungsten, molybdenum, iron or phosphorus.

18. The method of claim 1 wherein the body portion is moulded in a cup-shape.

19. The method of claim 1 wherein the body portion comprises an inlet wall, wherein the one or more piercing zones are located on the inlet wall.

20. The method of claim 1 wherein the one or more piercing zones comprise an annular zone.

21. The method of claim 20 wherein the annular zone is continuous in a circumferential direction.

22. The method of claim 20 wherein the annular zone is discontinuous in a circumferential direction.

23. The method of claim 21 wherein the annular zone comprises a circumferential pattern, preferably a repeating pattern.

24. The method of claim 1 wherein the one or more piercing zones comprise two or more concentrically arranged annular zones.

25. The method of claim 1, wherein the one or more piercing zones comprise a circular zone.

26. The method of claim 1 wherein the body portion has a thickness within the one or more piercing zones in the range of 0.20 to 0.50 mm, preferably within the range 0.30 to 0.40 mm.

27. The method of claim 1 wherein the one or more piercing zones comprise an area of 10 to 90% of an inlet wall area of the body portion.

28. The method of claim 1 further comprising masking of the polymeric material of a remainder of the body portion to prevent alteration of said remainder of the body portion during treatment.

29. The method of claim 1 wherein the body portion further comprises a sealing member configured to form a sealing engagement with an enclosing member of a beverage preparation machine to thereby prevent or limit a by-pass flow of water in use.

30. The method of claim 29 wherein the sealing member forms a part of the remainder of the body portion which is not treated.

31. The method of claims 29 wherein the one or more piercing zones of the body portion have a lower ductility than the sealing member.

32. A method of producing a capsule for the preparation of a beverage comprising the steps of:
producing a body portion as claimed in any preceding claim;
inserting beverage ingredients into the body portion; and
sealing the body portion with a lid.

33. A body portion of a capsule obtainable by the method of any of claim 1.

34. A capsule for the preparation of a beverage when utilised with a beverage preparation machine, the capsule comprising a body portion and a lid which together define an interior of the capsule for containing beverage ingredients;
wherein the body portion comprises one or more piercing zones intended to be pierced in use by one or more piercers of the beverage preparation machine to thereby provide one or more inlet apertures for feeding water under pressure into the interior of the capsule;
wherein the body portion is formed from a polymeric material;
wherein the polymeric material of the one or more piercing zones comprises a transformed structure which has been treated after formation of the body portion to alter one or more material characteristics of the polymeric material of the one or more piercing zones relative to the material characteristics of the polymeric material of a remainder of the body portion.

35. A capsule as claimed in claim 34 wherein the transformed structure comprises one or more of a degraded, carbonised, foamed, aged or embrittled structure.

36. A capsule as claimed in claims 34 wherein the body portion is moulded from the polymeric material.

37. A capsule as claimed in claim 34 wherein the body portion is a unitary moulding.

38. A capsule as claimed in claim 34 wherein the body portion is moulded from a single material.

39. A capsule as claimed in claim 34 wherein the body portion is injection-moulded.

40. A capsule as claimed in claim 34 wherein the body portion is formed from a material comprising a polyolefin.

41. A capsule as claimed in claim 34 wherein the body portion is formed from a material comprising a thermoplastic polyolefin.

42. A capsule as claimed in claim 34 wherein the body portion is formed from a material comprising polypropylene and/or polyethylene.

43. A capsule as claimed in claim 34 wherein the polymeric material comprises an additive intended to facilitate the treatment of the one or more piercing zones by radiant energy.

44. The capsule of claim 43 wherein the additive is one or more compounds selected from the group of: carbon black, graphite and doped-tin dioxide.

45. The capsule of claim 44 wherein the tin dioxide is doped with one or more of antimony, fluorine, chlorine, tungsten, molybdenum, iron or phosphorus.

46. A capsule as claimed in claim 34 wherein the body portion is cup-shaped.

47. A capsule as claimed in claim 34 wherein the body portion comprises an inlet wall, wherein the one or more piercing zones are located on the inlet wall.

48. A capsule as claimed in claim 34 wherein the one or more piercing zones comprise an annular zone.

49. A capsule as claimed in claim 48 wherein the annular zone is continuous in a circumferential direction.

50. A capsule as claimed in claim 48 wherein the annular zone is discontinuous in a circumferential direction.

51. A capsule as claimed in claim 49 wherein the annular zone comprises a circumferential pattern, preferably a repeating pattern.

52. A capsule as claimed in claim 34 wherein the one or more piercing zones comprise two or more concentrically arranged annular zones.

53. A capsule as claimed in claim 34 wherein the one or more piercing zones comprise a circular zone.

54. A capsule as claimed in claim 34 wherein the body portion further comprises a sealing member configured to form a sealing engagement with an enclosing member of a beverage preparation machine to thereby prevent or limit a by-pass flow of water in use.

55. The capsule of claim 54 wherein the sealing member forms a part of the remainder of the body portion which is not treated.

56. A capsule as claimed in claim 34 wherein the one or more piercing zones of the body portion have a lower ductility than the sealing member.
